(19) United States
(12) Patent Application Publication
(10) Pub. No.: US 2022/0127798 A1
(43) Pub. Date: Apr. 28, 2022

(54) DEVICE FOR GENERATING VIBRATIONS, GROUND COMPACTION MACHINE, AND METHOD OF OPERATING

(71) Applicant: BOMAG GmbH, Boppard (DE)

(72) Inventors: Hermann Christ, Boppard (DE); Marco Reuter, Boppard (DE)

(21) Appl. No.: 17/312,149

(22) PCT Filed: Dec. 17, 2019
(86) PCT No.: PCT/EP2019/000343

§ 371 Date: Jan. 3, 2022

(30) Foreign Application Priority Data
Dec. 28, 2018 (DE) 10 2018 010 154.2

(51) Int. Cl. E01C 19/28; E02D 3/074; B06B 1/16

(52) U.S. Cl. CPC E01C 19/286; B06B 1/162; E02D 3/074

(57) ABSTRACT

The present invention relates to a device for generating vibrations for a ground compaction machine, in particular a self-propelled ground compaction roller, comprising a first imbalance mass and a second imbalance mass, each of which is rotatably mounted, a first hydraulic motor configured to set the first imbalance mass into rotation, a planetary gear connected to the first hydraulic motor and via which the second imbalance mass can be driven, a second hydraulic motor which is also connected to the planetary gear and is configured to change the transmission ratio from the first hydraulic motor to the second imbalance mass via the planetary gear, wherein a third hydraulic motor is provided which is also connected to the planetary gear and is also configured to change the transmission ratio from the first hydraulic motor to the second imbalance mass via the planetary gear. Moreover, the present invention relates to a ground compaction machine and a method for operating the device and the ground compaction machine, respectively.

### CROSS-REFERENCE TO RELATED APPLICATION

The present application is a U.S. National Stage entry under 35 U.S.C. § 371 of, and claims priority to, International Application No. PCT/EP2019/000343, filed Dec. 17, 2019, which claims priority to German Patent Application No. 102018010154.2, filed Dec. 28, 2018, the disclosures of which are hereby incorporated herein by reference in their entireties.

### FIELD OF THE INVENTION

The present invention relates to a device for generating vibrations for a ground compaction machine, in particular a self-propelled ground compaction roller. Moreover, the present invention relates to a ground compaction machine with at least one such device and a method for operating the device and the ground compaction machine, respectively.

### BACKGROUND OF THE INVENTION

Ground compaction machines of this type are, in particular, self-propelled ground compaction rollers, for example tandem rollers or single-drum rollers. Such ground compaction machines are typically used in the construction of roads, paths and squares and comprise at least one compaction drum that is used to compact the ground when the roller is in operation. The ground is compacted, for example, by the dead weight of the roller and the compaction drum. In order to increase the compaction performance, it is known to set the compaction drum into vibration. It is also known to adjust the vibrations of the compaction drums both in their frequency and in their direction of action in order to meet different requirements of the respective construction site. Generic systems are disclosed, for example, in DE 10 235 976 A1 and DE 10 321 666 A1. However, such systems having adjustment options for both the vibration frequency and the vibration plane are complex in design and therefore involve high manufacturing costs.

One aspect of the present invention is to provide simpler and thus more cost-efficient ways of generating vibrations in generic ground compaction machines. At the same time, the entire functional spectrum of said generic machines is to be retained.

### SUMMARY OF THE INVENTION

Specifically, the device for generating vibrations for a ground compaction machine, in particular a self-propelled ground compaction roller, comprises a first imbalance mass and a second imbalance mass, which are each rotatably mounted, a first hydraulic motor configured to set the first imbalance mass into rotation, a planetary gear which is connected to the first hydraulic motor and via which the second imbalance mass can be driven, and a second hydraulic motor which is also connected to the planetary gear and is configured to change the transmission ratio from the first hydraulic motor to the second imbalance mass via the planetary gear. The present invention is now characterized in that a third hydraulic motor is provided which is also connected to the planetary gear and is also configured to change the transmission ratio from the first hydraulic motor to the second imbalance mass via the planetary gear. The first hydraulic motor thus drives the first imbalance mass directly and the second imbalance mass indirectly via the planetary gear. The transmission of the drive power from the first hydraulic motor to the second imbalance mass can be regulated by the planetary gear, especially by using the second and third hydraulic motors. The first imbalance mass thus always rotates at the same speed or frequency as the first hydraulic motor. The vibration frequency of the entire arrangement can be changed or adjusted by regulating the running speed of the first hydraulic motor. The second and third hydraulic motors can be used to adjust the frequency of the second imbalance mass by having these hydraulic motors act on the summation gear, in this case the planetary gear. In addition, the phase position of the second imbalance mass can be adjusted relative to the first imbalance mass, so that the total amplitude resulting from the rotation of both imbalance masses can be adjusted. By shifting the phase between the first and second imbalance masses from 0° to 180°, the total amplitude can be adjusted between its maximum value and zero.

In principle, the first hydraulic motor can drive the first imbalance mass via any direct drive train. According to one embodiment of the present invention, the first hydraulic motor drives the first imbalance mass via an output shaft passing through the planetary gear. The first hydraulic motor is thus directly connected to the first imbalance mass via a single output shaft. The fact that this output shaft passes through the planetary gear results in a particularly space-saving and simple embodiment.

A planetary gear may comprise a sun wheel as well as planet wheels meshing with the sun wheel, and a ring wheel in turn meshing with the planet wheels. According to the present invention, the planetary gear now has a further ring wheel which meshes with a further set of planet wheels, the further planet wheels also meshing with the sun wheel of the planetary gear. Thus, the planetary gear according to the present invention has a sun wheel, two sets of planet wheels and two ring wheels. The ring wheels are configured to rotate independently of each other. In one embodiment of the present invention, first planet wheels of the planetary gear are configured to be drivable by the first hydraulic motor, and a first ring wheel is configured to be drivable by the second hydraulic motor, wherein the first ring wheel meshes with the first planet wheels, and wherein the second imbalance mass is drivable via a sun wheel of the planetary gear meshing with the first planet wheels. The first hydraulic motor thus transfers its drive power to the planetary gear via the first planet wheels. The transmission ratio of this power to the sun wheel can be adjusted by the second hydraulic motor via the first ring wheel. The power to be transmitted to the second imbalance mass thus comes from the first hydraulic motor and is passed on via the sun wheel.

According to another embodiment of the present invention, the sun wheel of the planetary gear meshes with both the first planet wheels and the second planet wheels, wherein the first planet wheels mesh only with the first ring wheel and the second planet wheels mesh only with a second ring wheel, and wherein the second ring wheel is configured to be drivable by the third hydraulic motor. The term “only” here refers only to the ring wheels. Both sets of planet wheels also mesh with the sun wheel. It is important to note, however, that each set of planet wheels meshes with only one ring wheel, the ring wheels being rotatable independently of each other. In the arrangement described, it is possible that the second imbalance mass is drivable via the second planet wheels meshing with the sun wheel. The power input by the first hydraulic motor to drive the second imbalance mass is thus passed on from the first hydraulic motor via the first planet wheels to the sun wheel and from the sun wheel to the second planet wheels, from which the second imbalance mass is driven.

The first hydraulic motor must be capable of driving the two imbalance masses even at high speeds or high frequencies. The second hydraulic motor and the third hydraulic motor, on the other hand, are designed to rotate the two imbalance masses relative to each other, i.e., to change their phase position. In order to enable precise adjustment of the phase position of the imbalance masses, it is important that the second and third hydraulic motors can be operated as accurately as possible, particularly at low frequencies, i.e., at slow speeds. According to one embodiment of the present invention, the second hydraulic motor and/or the third hydraulic motor are therefore orbital motors. Orbital motors are characterized by particularly good slow-running behavior and also offer advantages due to their low installation space requirements. By using orbital motors, the desired phase positions of the imbalance masses can be precisely set. Moreover, in order to make the corresponding control of the phase position via the second and third hydraulic motors even more precise, it is possible that the second hydraulic motor and/or the third hydraulic motor comprise a brake. The brake also improves the accuracy of small adjustments on the hydraulic motors. In addition, the brake can be used to lock the second and third hydraulic motors—and thus the ring wheels—so that in each case the entire power is transmitted between the planet wheels and the sun wheel.

The aspect of the present invention described at the beginning is also achieved with a ground compaction machine, in particular a self-propelled ground compaction roller, with at least one device for generating vibrations according to any one of the preceding claims. The features, effects and advantages described above for the device for generating vibrations also apply accordingly to the ground compaction machine according to the present invention.

According to one embodiment of the present invention, the ground compaction machine has two devices for generating vibrations, as described above, which are configured to rotate in opposite directions. In particular, two devices for generating vibrations are provided in each compaction drum of the ground compaction machine. The two imbalance masses of the first device for generating vibrations thus have a direction of rotation opposite to the two imbalance masses of the second device for generating vibrations. As already described above, by adjusting the phase position of the imbalance masses of a device for generating vibrations, the amplitude of the vibration can be adjusted. When two counter-rotating devices are used to generate vibrations, the superposition of the two individual vibrations results in a directional overall vibration. The vibration power is therefore only introduced into the ground in one direction. Moreover, this direction can be varied depending on the application by changing the phase position of the two devices for generating vibrations with respect to each other by temporarily adjusting the rotational speed or frequency. In this way, the amplitude of the resulting overall vibration, as well as its direction and its frequency, can be continuously varied by the device according to the present invention.

The aspect of the present invention described at the beginning is also achieved by a method for operating a device for generating vibrations, in particular a device for generating vibrations described above. The method according to the present invention comprises the steps of: driving a first imbalance mass by a first hydraulic motor, driving a second imbalance mass by the first hydraulic motor via a planetary gear, adjusting the transmission ratio of the planetary gear between the first hydraulic motor and the second imbalance mass by a second hydraulic motor connected to the planetary gear, and adjusting the transmission ratio of the planetary gear between the first hydraulic motor and the second imbalance mass by a third hydraulic motor connected to the planetary gear. Furthermore, the object is achieved with a method for operating a ground compaction machine as described above, wherein the ground compaction machine has two devices for generating vibrations which are configured to rotate in opposite directions, and wherein the two devices for generating vibrations are each operated with the method for operating a device for generating vibrations described above. All of the above-described features, effects and advantages of the device for generating vibrations according to the present invention and of the ground compaction machine according to the present invention also apply mutatis mutandis to the methods according to the present invention.

### BRIEF DESCRIPTION OF THE DRAWINGS

The present invention will be explained in more detail below by reference to the embodiment examples shown in the figures. In the schematic figures:

FIG. 1 is a side view of a tandem roller;

FIG. 2 is a side view of a single-drum roller;

FIG. 3 shows a device for generating vibrations;

FIG. 4 is a flowchart of a method for operating a device for generating vibrations; and

FIG. 5 is a flowchart of a method for operating a ground compaction machine.

Like parts or functionally like parts are designated by like reference numerals in the figures. Recurring parts are not designated separately in each figure.

### DETAILED DESCRIPTION OF THE INVENTION

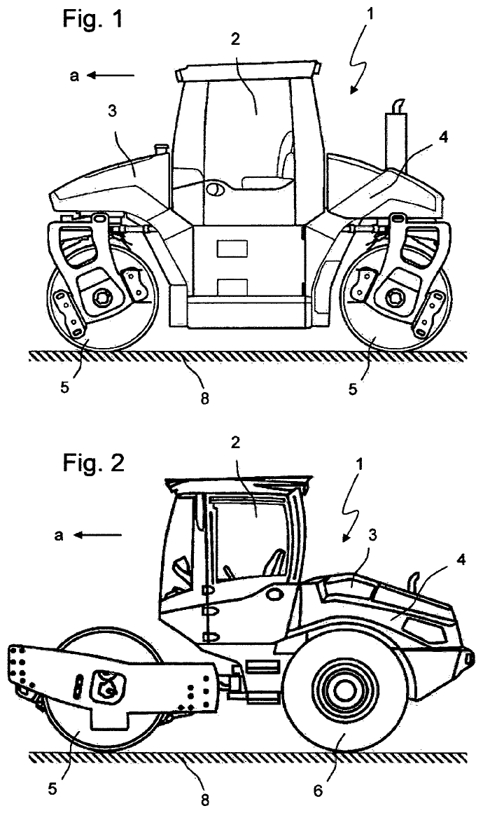

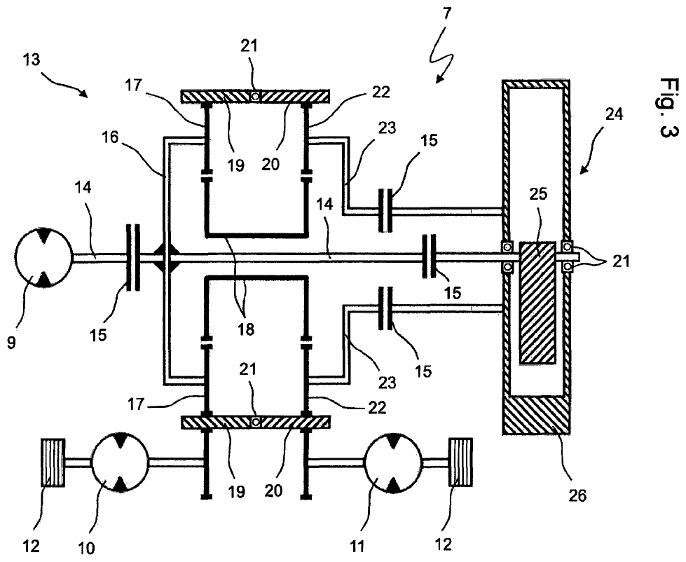

FIGS. 1 and 2 show ground compaction machines 1. In the case of FIG. 1, the roller is a pivot-steered tandem roller, while FIG. 2 shows an articulated-steered single-drum roller. The ground compaction machines 1 include an operator platform 2 and a machine frame 3. In addition, the self-propelled ground compaction machines 1 comprise a drive motor 4 that, among other things, drives the traveling mechanism of the ground compaction machines 1. In the case of the tandem roller shown in FIG. 1, said traveling mechanism comprises a front and a rear compaction drum 5. The single-drum roller according to FIG. 2 has only a front compaction drum 5 and also includes a set of wheels 6 at the rear of the machine. In operation, the ground compaction machines 1 move over the ground 8 in or against the working direction a, compacting the subsoil.

FIG. 3 shows a device for generating vibrations 7, comprising a drive train with a planetary gear 13 and a vibration exciter 24 with a first imbalance mass 25 and a second imbalance mass 26. The rotation axes of the two imbalance masses 25, 26 are superimposed so that the imbalance masses 25, 26 rotate on concentric circles. In particular, two such devices for generating vibrations 7 are arranged in each of the compaction drums 5 of the ground compaction machines 1. The device for generating vibrations 7 comprises a first hydraulic motor 9, which drives an output shaft 14. The output shaft 14 is guided through a planetary gear 13 and drives a first imbalance mass 25, which is set into rotation via the output shaft 14. The rotational speed of the first imbalance mass 25 therefore corresponds to the rotational speed of the first hydraulic motor 9. Moreover, the drive power of the first hydraulic motor 9 is also transmitted, via the output shaft 14 and a drive web 16 connected to the output shaft 14, to a set of first planet wheels 17 of the planetary gear 13. The first planet wheels 17 mesh with both a sun wheel 18 and a first ring wheel 19 of the planetary gear 13. The first ring wheel 19 is in turn connected to a second hydraulic motor 10 so that the first ring wheel 19 can be driven by the second hydraulic motor 10. As is usual with summation gears, it is therefore possible to continuously regulate the proportion of the drive power transmitted from the first planet wheels 17 to the sun wheel 18 via the second hydraulic motor 10 by driving or locking the first ring wheel 19. For example, all the power coming from the first planet wheels 17 is transmitted to the sun wheel 18 when the ring wheel 19 is locked by the second hydraulic motor 10. Depending on how fast the second hydraulic motor 10 drives the first ring wheel 19, this power can be continuously adjusted down to zero.

Functionally and spatially separate from the first planet wheels 17, the sun wheel 18 also meshes with a set of second planet wheels 22. These second planet wheels 22 also mesh with a second ring wheel 20 of the planetary gear 13. The second ring wheel 20 is in turn connected to and can be driven by a third hydraulic motor 11. In this way, the drive power coming from the sun wheel 18, which is available via the second planet wheels 22, can be continuously regulated. For example, if the third hydraulic motor 11 locks the second ring wheel 20, all of the power coming from the sun wheel 18 is transferred to and available at the second planet wheels 22. The second planet wheels 22 are connected to an output web 23, which is used to set the second imbalance mass 26 into rotation. Thus, the second imbalance mass 26 is also driven by the first hydraulic motor 9 via the drive path through the planetary gear 13 described above.

To enable precise adjustment of the phase position of the imbalance masses 25, 26, the second hydraulic motor 10 and/or the third hydraulic motor 11 are designed as orbital motors and are each equipped with a brake 12. In this way, even small adjustments for precise control can be realized. The brakes 12 can also be used to lock the hydraulic motors 10, 11, thereby arresting the ring wheels 19, 20. In order to simultaneously enable a compact design and ensure that the two ring wheels 19, 20 are configured to rotate independently of each other, the two ring wheels 19, 20 are connected to each other via bearings 21, in particular ball bearings.

In order to be able to uncouple individual components of the device for generating vibrations 7, couplings 15 are provided at various points between the first hydraulic motor 9 and the vibration exciter 24. For example, a coupling 15 is located on the output side directly downstream of the first hydraulic motor 9. Thus, when this coupling 15 is uncoupled, both the first imbalance mass 25 and the planetary gear 13, and thus the second imbalance mass 26, are uncoupled from the drive by the first hydraulic motor 9. Moreover, another coupling 15 is located on the output shaft 14 downstream of the connection to the drive web 16, which supplies power from the first hydraulic motor 9 to the planetary gear 13. Disconnecting this coupling 15 therefore only disconnects the first imbalance mass 25 from the drive. Further couplings 15 are provided on the output web 23, connecting the second planet wheels 22 to the second imbalance mass 26. The second imbalance mass 26 can therefore be uncoupled via these couplings 15.

The vibration exciter 24 is configured such that the two imbalance masses 25, 26 rotate about the same rotation axis. In particular, both imbalance masses 25, 26 of a device for generating vibrations rotate in the same direction. In this configuration, the second imbalance mass 26 is designed as a housing with a cavity in which the first imbalance mass 25 is accommodated. The output shaft 14 of the first hydraulic motor 9 is thus guided into the cavity of the second imbalance mass 26 and supported with respect to the second imbalance mass 26 by bearings 21, in particular ball bearings, so that the second imbalance mass 26 can move independently of the output shaft 14. The output shaft 14 drives the first imbalance mass 24 within the second imbalance mass 26.

Overall, the phase position of the imbalance masses 25, 26 can be accomplished by temporarily adjusting the transmission ratio of the planetary gear 13 by the second hydraulic motor 10 or the third hydraulic motor 11. In this way, the imbalance masses 25, 26 are rotated relative to each other. By adjusting the phase position of the imbalance masses 25 and 26 rotating in the same direction, the resulting amplitude of the vibration can thus be continuously adjusted from zero to its maximum value. By adjusting the rotational speed of the first hydraulic motor 9, the overall exciter frequency of the vibration exciter 24 can be adjusted. If two devices for generating vibrations 7 are used simultaneously in a compaction drum 5, and in such a way that the imbalance masses 25, 26 of one device rotate in the opposite direction to that of the other device, a directional vibration can also be achieved in this way. In this case, those parts of the respective individual vibrations that do not point in the same direction cancel each other out. In this way, by using two devices for generating vibrations 7, the arrangement according to the present invention can represent a directional vibrator whose direction, amplitude and vibration frequency can each be adjusted continuously from zero to the maximum value.

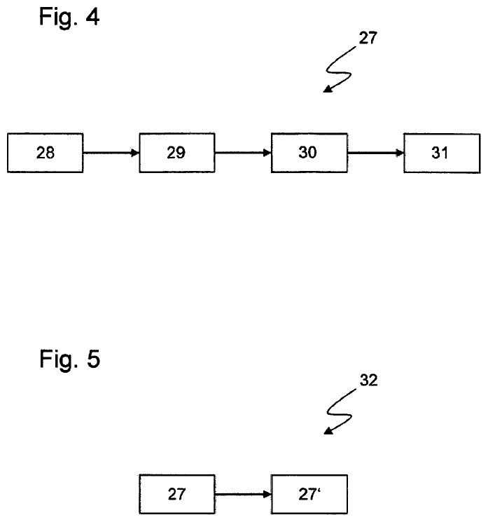

FIG. 4 shows a flowchart of the method 27 for operating a device for generating vibrations 7. The method comprises the steps of: driving 28 the first imbalance mass 25 by the first hydraulic motor 9, driving 29 the second imbalance mass 26 by the first hydraulic motor 9 via the planetary gear 13, adjusting 30 the transmission ratio of the planetary gear 13 between the first hydraulic motor 9 and the second imbalance mass 26 by the second hydraulic motor 10 connected to the planetary gear 13, and adjusting 31 the transmission ratio of the planetary gear 13 between the first hydraulic motor 9 and the second imbalance mass 26 by a third hydraulic motor 11 connected to the planetary gear 13. In particular, these steps may also be performed simultaneously. FIG. 5 shows a method 32 for operating a ground compaction machine 1 with two devices for generating vibrations 7. Each of the two devices for generating vibrations 7 is operated using a method 27 according to FIG. 4. For the second device for generating vibrations 7, the method is designated with 27′. It will be understood that the two devices for generating vibrations 7 are also operated simultaneously in method 32.

What is claimed is:

1. A device for generating vibrations for a ground compaction machine, comprising:
a first imbalance mass and a second imbalance mass, each of which is rotatably mounted;
a first hydraulic motor configured to set the first imbalance mass into rotation;
a planetary gear which is connected to the first hydraulic motor and via which the second imbalance mass is driven;
a second hydraulic motor which is also connected to the planetary gear and configured to change the transmission ratio from the first hydraulic motor to the second imbalance mass via the planetary gear,
wherein a third hydraulic motor is provided which is also connected to the planetary gear and is also configured to change the transmission ratio from the first hydraulic motor to the second imbalance mass via the planetary gear.

2. The device for generating vibrations according to claim 1,
wherein the first hydraulic motor drives the first imbalance mass via an output shaft passing through the planetary gear.

3. The device for generating vibrations according to claim 1,
wherein first planet wheels of the planetary gear are configured to be drivable by the first hydraulic motor and a first ring wheel is configured to be drivable by the second hydraulic motor, wherein the first ring wheel meshes with the first planet wheels, and wherein the second imbalance mass is drivable via a sun wheel of the planetary gear meshing with the first planet wheels.

4. The device for generating vibrations according to claim 3,
wherein the sun wheel of the planetary gear meshes with both the first planet wheels and second planet wheels, wherein the first planet wheels mesh only with the first ring wheel and the second planet wheels mesh only with a second ring wheel, and wherein the second ring wheel is configured to be drivable by the third hydraulic motor.

5. The device for generating vibrations according to claim 4,
wherein the second imbalance mass is drivable via the second planet wheels meshing with the sun wheel.

6. The device for generating vibrations according to claim 2,
wherein the second hydraulic motor and/or the third hydraulic motor is an orbital motor.

7. The device for generating vibrations according to claim 1,
wherein the second hydraulic motor and/or the third hydraulic motor comprises a brake.

8. A ground compaction machine having at least one device for generating vibrations according to claim 1.

9. The ground compaction machine according to claim 8,
wherein the around compaction machine comprises two devices for generating vibrations according to claim 1, which are configured to rotate in opposite directions.

10. A method for operating a device for generating vibrations according to claim 1, comprising the steps of:
driving a first imbalance mass by a first hydraulic motor,
driving a second imbalance mass by the first hydraulic motor via a planetary gear,
adjusting the transmission ratio of the planetary gear between the first hydraulic motor and the second imbalance mass by a second hydraulic motor connected to the planetary gear, and
adjusting the transmission ratio of the planetary gear between the first hydraulic motor and the second imbalance mass by a third hydraulic motor connected to the planetary gear.

11. The method for operating a ground compaction machine comprising two devices for generating vibrations according to claim 1, which are configured to rotate in opposite directions,
wherein the two devices for generating vibrations are each operated using a method comprising the steps of:
driving a first imbalance mass by a first hydraulic motor,
driving a second imbalance mass by the first hydraulic motor via a planetary gear,
adjusting the transmission ratio of the planetary gear between the first hydraulic motor and the second imbalance mass bv a second hydraulic motor connected to the planetary gear, and
adjusting the transmission ratio of the planetary gear between the first hydraulic motor and the second imbalance mass bv a third hydraulic motor connected to the planetary gear.

12. The device for generating vibrations according to claim 1,
wherein the ground compaction machine comprises a self-propelled compaction roller.

13. The ground compaction machine according to claim 8,
wherein the ground compaction machine comprises a self-propelled compaction roller.
